(19) United States
(12) Patent Application Publication
(10) Pub. No.: US 2019/0236604 A1
(43) Pub. Date: Aug. 1, 2019

(54) SYSTEM AND METHOD FOR VERIFYING RETAIL RETURNS USING BLOCKCHAIN

(71) Applicant: Walmart Apollo, LLC, Bentonville, AR (US)

(72) Inventors: Brian MCHALE, Oldham (GB); David M. NELMS, Rogers, AR (US); John J. O'BRIEN, Farmington, AR (US); Robert CANTRELL, Herndon, VA (US)

(73) Assignee: Walmart Apollo, LLC, Bentonville, AR (US)

(21) Appl. No.: 16/262,574

(22) Filed: Jan. 30, 2019

Related U.S. Application Data
(60) Provisional application No. 62/624,718, filed on Jan. 31, 2018.
(60) Provisional application No. 62/624,717, filed on Jan. 31, 2018.

(51) Int. Cl. G06Q 20/40; G06Q 20/38

(52) U.S. Cl. CPC G06Q 20/407; G06Q 20/389; G06Q 20/40145

(57) ABSTRACT

Systems, methods, and computer-readable storage media for verifying a product being returned is a product which was sold by using blockchain security systems. At a first time, the system identifies a blockchain specific to an item being sold, then generates a new block for the blockchain with information about the sale. When an item is being returned, the system retrieves the blockchain and compares the data contained within the sale block to data associated with the product and/or the customer returning the product. If a match is found, the product is returned and the blockchain is further updated with the return information.

### PRIORITY

The present application claims priority to U.S. Provisional Application No. 62/624,718, filed Jan. 31, 2018, and U.S. Provisional Application No. 62/624,717, filed Jan. 31, 2018, the contents of which are incorporated herein in their entirety.

### BACKGROUND

### 1. Technical Field

The present disclosure relates to a blockchain system for supply chain management, and more specifically to a blockchain system that verifies that a returned product was sold by the retailer to which it is being returned.

### 2. Introduction

Retail fraud often occurs as products are returned, when in reality the products were never purchased to begin with. One common way this occurs is when a receipt is found in a parking lot. The finder of the receipt can then go into the store, obtain a new version of the product listed on the receipt, and attempt to exchange the new version of the product with the receipt for cash.

### SUMMARY

An exemplary method which can be performed according to the concepts disclosed herein can include: at a first time: identifying, via a processor having access to a blockchain database on a distributed computing system, a blockchain associated with a first product stored at a retail location, the blockchain containing a supply chain record of the first product from a manufacturer to the retail location; identifying a sale of the first product; in response to the sale of the first product, generating a new block for the blockchain, the new block including information regarding the sale; adding the new block to the blockchain, to yield a modified blockchain; and distributing the modified blockchain to the distributed computing system; at a second time: receiving a notification of a second product being returned to the product location; retrieving the modified blockchain from the distributed computing system; comparing the second product to the new block, to yield a comparison; determining, based on the comparison, that the second product is the first product; accepting the second product as a returned product; updating the modified blockchain based on the returned product, to yield an updated blockchain; and distributing the updated blockchain to the distributed computing system.

An exemplary system configured according to this disclosure can include: a processor having access to a blockchain database on a distributed computing system; and a computer-readable storage medium having instructions stored which, when executed by the processor, cause the processor to perform operations comprising: at a first time: identifying a blockchain associated with a first product stored at a retail location, the blockchain containing a supply chain record of the first product from a manufacturer to the retail location; identifying a sale of the first product; in response to the sale of the first product, generating a new block for the blockchain, the new block including information regarding the sale; adding the new block to the blockchain, to yield a modified blockchain; and distributing the modified blockchain to the distributed computing system; at a second time: receiving a notification of a second product being returned to the product location; retrieving the modified blockchain from the distributed computing system; comparing the second product to the new block, to yield a comparison; determining, based on the comparison, that the second product is the first product; accepting the second product as a returned product; updating the modified blockchain based on the returned product, to yield an updated blockchain; and distributing the updated blockchain to the distributed computing system.

An exemplary non-transitory computer-readable storage medium configured according to this disclosure can have instructions stored which, when executed by a computing device, cause the computing device to perform operations which can include: at a first time: identifying a blockchain associated with a first product stored at a retail location, the blockchain containing a supply chain record of the first product from a manufacturer to the retail location; identifying a sale of the first product; in response to the sale of the first product, generating a new block for the blockchain, the new block including information regarding the sale; adding the new block to the blockchain, to yield a modified blockchain; and distributing the modified blockchain to the distributed computing system; at a second time: receiving a notification of a second product being returned to the product location; retrieving the modified blockchain from the distributed computing system; comparing the second product to the new block, to yield a comparison; determining, based on the comparison, that the second product is the first product; accepting the second product as a returned product; updating the modified blockchain based on the returned product, to yield an updated blockchain; and distributing the updated blockchain to the distributed computing system.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an example of a blockchain being updated throughout a supply chain;

FIG. 2 illustrates an exemplary flowchart which can be used to verify a notification using blockchain technology;

FIG. 3 illustrates how a customer's data can be used to generate a pseudo-private key;

FIG. 4 illustrates an exemplary method embodiment; and

FIG. 5 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

Systems configured according to this disclosure can use blockchains to verify sales of products, and more specifically, confirm that a product being returned was sold by a given retailer. As the product moves from manufacturer to retailer to customer through a supply chain, each transaction or stage can result in a new block being added to the blockchain. For example, as a manufacturer creates a t-shirt, a new blockchain can be established for that t-shirt. As the manufacturer ships the t-shirt from the manufacturing plant to a distribution center, a new block can be added to the blockchain with information about the means of transportation used to ship the t-shirt. This process of adding blocks can continue through until the t-shirt is sold, at which point the blockchain can be finalized or completed with a block containing information about the sale and/or about the customer purchasing the t-shirt.

When a customer then returns the t-shirt to the store, the system can retrieve the blockchain associated with that t-shirt. If the t-shirt's blockchain has not been finalized with either sale information or customer information, the system can determine that the product is being returned under false pretenses. If, however, the t-shirt's blockchain does contain information about the sale and/or customer information (i.e., the t-shirt has been sold), the system can compare the product being returned, the customer's identification, and/or other aspects of the product to the blockchain.

When the comparison yields information confirming the sale, the product being returned can be confirmed as the product sold, and the return of the product can be authorized. A new block, containing information regarding the return, can then be generated and added to the product's blockchain. The information contained in the new/return block can provide details regarding why the product was returned, who returned it, at what location it was returned (if, for example, the retailer owns multiple locations), if it was returned with or without a receipt, and/or customer information (such as name, address, phone number, email, other contact information, driver's license number, etc.). The new/return block can also contain information access information, such as blockchain keys (private and/or public, depending on specific configuration).

To speed up this process, in some configurations, the system can generate a token at time of sale. This token can be transferred to the customer, such that when the product is returned, the customer can present the token. The token can provide a key/authorization to the blockchain, enabling a swifter return authorization.

In some configurations, additional data at any given point in the supply chain can result in a sidechain, or side blocks, being added to a block on the blockchain. For example, if a retail store obtains an item, a block may be added to the block chain for that item with information about the retail location, time when possession occurred, location within the retail store, price, discounts, etc. If there is a price change, discount, etc., available, a side block can be generated and added to the retail store block on the blockchain. In some configurations, the side block can be attached to the blockchain such that subsequent blocks (like that of a sale) do not directly refer back to the side block, but instead refer back to the retail block. In other configurations, the side block functions as a normal block (having a reference back to the previous block and being referenced by a subsequent block), but contains abbreviated information compared to a normal block.

With reference to the physical memory of a side block, the storage location within the memory can vary as required. Likewise, the generation of side blocks can follow block generation standards. However, the linking process, where a normal blockchain has the subsequent blocks record the identifying information of the previous block, in this case records the identifying information of a previous block. Additions to the sidechain would then record the identifying information of the sidechain block from which it is extending. In this manner, blockchains can extend in multiple directions rather than linearly.

When a recall is issued by a manufacturer, a supply chain blockchain as described herein allows the system to identify all products created by the manufacturer which are currently in stock, as well as those products which have been sold within a period of time. This system allows the retailer to pull products from retail locations, transportation systems, and/or distribution centers prior to sale. For those products which have already been sold, the system also allows for communication to be initiated with those customers who purchased the product. Specifically, the system, upon receiving a notification indicating a recall, can (1) identify the products currently in inventory or in transit which need to be recalled, and may pull those products from distribution; and (2) identify the customers who purchased the products from the customer information added to the blockchain at point of sale. In this manner, the system provides for an enhanced method of communicating product safety information, while maintaining security regarding customer contact information (due to the difficulty in reverse engineering of blockchain keys).

In some configurations, the blocks associated with the sale or the purchasing customer can have information regarding the intended use of the item. For example, if the item is being purchased as a gift, that information can be recorded in the sale block within the blockchain. Then, if the recipient of the item were to attempt to return the product, a record that the item was a gift could indicate that a receipt might not be present, or that identification by the recipient shouldn't match that of the purchaser. If a token were generated by the system in a gifting circumstance, the purchaser may have the ability to transfer the token to the gift recipient, such that future returns may be better facilitated.

The block created for the blockchain when the sale of any particular item occurs can include information about the price at the time of sale, the date/time, the number of items being sold, discounts applied at the time of sale, product type/identification, serial number of the product, a serial number of the exchange, etc. In some configurations, this block can refer back to side blocks associated with the retail block, the side blocks outlining price and/or location changes.

The sale block can also contain information about the customer making the purchase. Alternatively, an additional block can be generated when the customer information is provided. The customer information can include name, contact information (e.g., address, phone number, email address, etc.), driver's license number, and/or demographic data (such as age, gender).

For cash customers attempting to return items without a receipt, the system can make use of the customer's driver's license number, biometric data (such as fingerprint or retinal scan), name, address, etc., to create a pseudo-private key for use on the blockchain. This pseudo-private key can then be used in encrypting the data into the block which will be recorded on the blockchain. The system can maintain a public key version based on the pseudo-private key, with the public key protecting the private information of the customer while still enabling the system to verify the contents of the block.

Systems configured according to this disclosure can receive the data associated with the customer, or the returnee, and perform an analysis on this information to determine patterns of purchases, returns, etc. For example, the system can compare the blockchains for similar items to determine where a given product sells best at different times of day, what types of demographics are purchasing the product, and the price which will result in the most effective profit. For cash customers, the pseudo-private key could be re-used for subsequent returns and used to track the number and type of item returned by the customer over time.

Computer systems which operate the blockchain systems disclosed herein require access to a distributed ledger, which is distributed among multiple computers, where each transaction in the blockchain is verified by other computers storing pieces (or the entirety) of the distributed ledger. These computers also have access to a hash table, allowing them to verify transactions under consideration for addition to the blockchain. Computer systems and processors which do not have access to the distributed ledger and/or the hash table may be incapable of performing the processes disclosed herein.

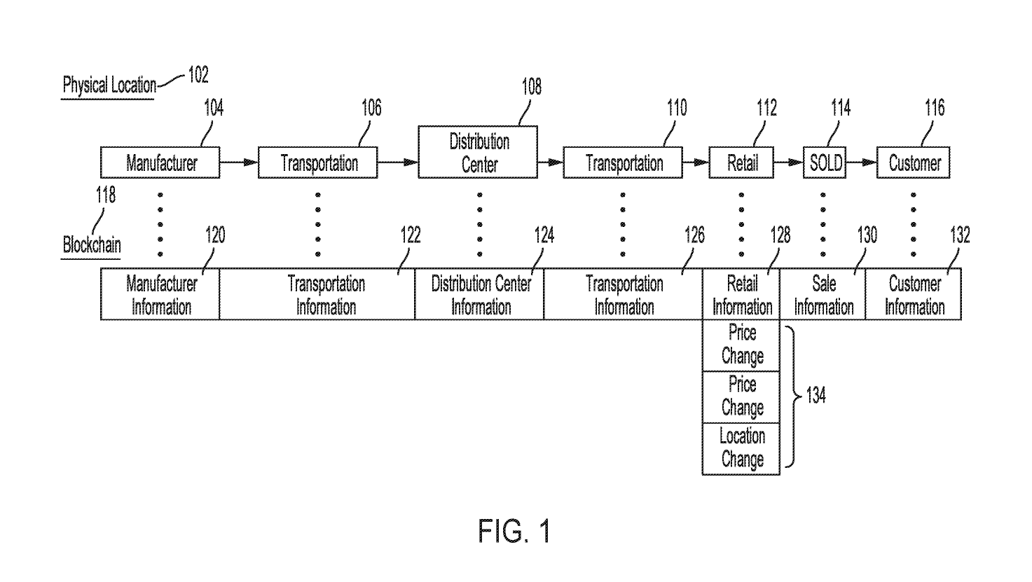

Having provided some examples, the disclosure next turns to the specific examples provided in FIGS. 1-5. While specific examples are given, systems configured according to this disclosure can exclude, add, or modify steps or features as required for a specific circumstance or configuration.

FIG. 1 illustrates an example of a blockchain 118 being updated throughout a supply chain. At the product progresses through physical locations 102, each subsequent stage results in a new block being added to the blockchain 118. For example, as illustrated, the product begins at a manufacturer 104, which results in the generation of a block 120 beginning the blockchain 118. The manufacturer block 120 can contain information such as the serial number of the specific item; the item type; the manufacturer location; the lot number in which the item was created; the date/time of manufacturer; (in the case of produce) the tree, lot, or row where the item was grown; and/or worker information for the workers associated with the item's creation.

As the item is transferred to transportation 106 mechanism (such as a truck, train, ship, forklift, pallet, etc.), information about the transportation 106 mechanism is stored in a block 122. This new block 122 is verified by other computing systems using the blockchain 118/distributed ledger system, then combined with the previous block 120. Data contained within this block 122 can include the shipping vendor, their licensure, truck number, car number, pallet number, etc.

When the transportation 106 delivers the item to a distribution center 108, the item can be stored and/or sorted prior to transportation 110 to a retail store 112. At each instance 108, 110, blocks 124, 126 are generated with associated data. Data which can be stored in the distribution center block 124 can include when the product was received, where in the distribution center 108 it is stored, who accepted the product's receipt, who moved the product within the distribution center 108, etc. The additional transportation 110 from the distribution center 108 to the retail location 112 can have the same types of data previously discussed.

When the retail store 112 takes possession of the item, a retail block 128 can be generated. Additional data can be added to the retail block 128 in the form of side blocks 134 each time aspects of the item's price, location within the retail store, sales, discounts, coupons, 2-for-1 specials, etc., are applied. These side blocks 134 can form a side chain which is not directly referenced by subsequent blocks 130, 132. Nevertheless, in some configurations those additional blocks 130, 132 may directly reference the side blocks 134.

As the item is sold 114, a block 130 can be generated and added to the blockchain 118 with information about the sale, such as when the sale occurred, how many items were purchased, if the item was purchased with cash, if the item was purchased via credit card, etc. Likewise, as the customer 116 takes ownership of the item, data associated with the customer 116 can be captured in a customer information block 132. The customer information block 132 can capture data such as the customer name, address, phone number, email address, other contact information, demographic, etc. When a product is returned, data associated with the blockchain 118, and in particular the sale information 130 and customer information 132, can be used to verify that the product was sold (and that the returner of the product should receive compensation for the product).

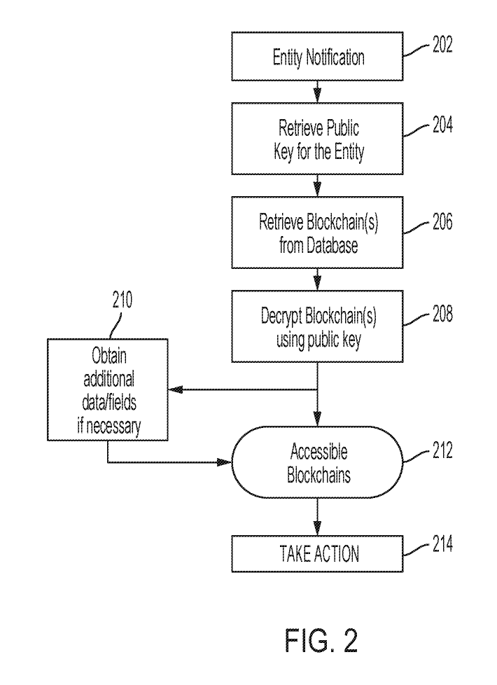

FIG. 2 illustrates an exemplary flowchart which can be used to verify a notification using blockchain technology. In this example, a system receives an entity notification 202 indicating that the entity is attempting to return a product. The system retrieves a public key for the entity 204 from a hash table or other database system. The public key allows the system to identify blockchains associated with the entity. For example, if the entity is a customer, the public key would allow the system to identify the blockchains for products which have been purchased or otherwise associated with the customer. In this case, the system uses the public key to retrieve blockchain(s) from a database 206, then decrypts the blockchain(s) using the public key 208. If additional data is necessary to determine if the item being returned by the entity was actually sold, the system can obtain additional data/fields 210. At this point, the system has accessible blockchains 212 which can be used to analyze if the item being returned by the entity was actually sold, allowing the system to take action 214. Exemplary actions 214 can include accepting the product as a returned product (and subsequently adding to/updating the blockchain for that product), rejecting the item as a returned product (and possibly identifying the product as a stolen item/alerting authorities), and/or requesting yet further information.

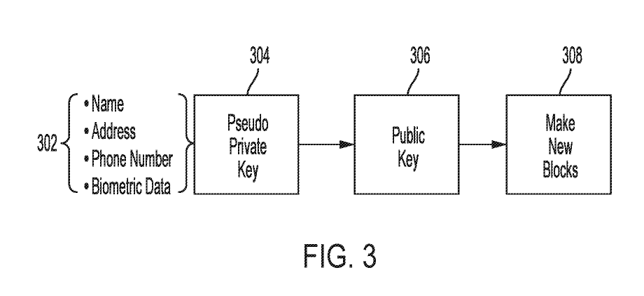

FIG. 3 illustrates how a customer's data can be used to generate a pseudo-private key. Whereas blockchain applications assign customers/users a private key which acts as a signature for the customer, in several applications discussed herein a customer may not have a private key assigned for use on the blockchains associated with the products being sold. In such instances, data 302 associated with the customer, such as name, address, phone number, biometric data, etc., can be used to generate a pseudo-private key 304. This pseudo-private key 304 can then operate as an effective signature for the customer upon making purchases and/or returns. It can be hashed to form a public key 306, which in turn can be used directly in the formation of new blocks 308, without risking making the private key 304 public.

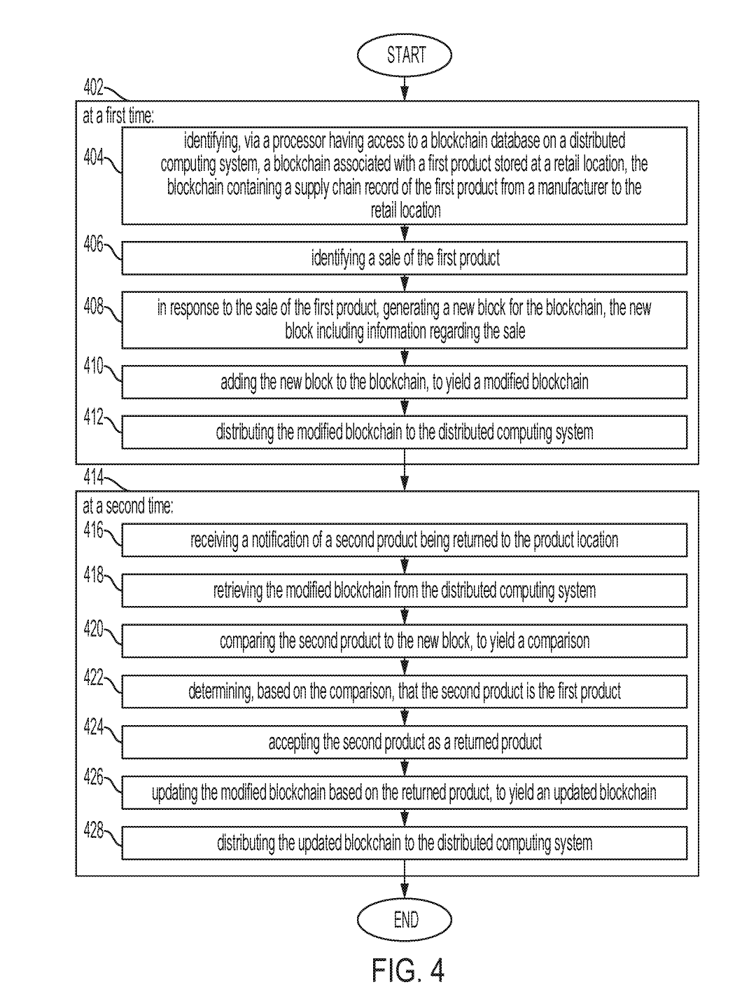

FIG. 4 illustrates an exemplary method embodiment. In this example, a system performs operations at two separate times (402), (414). At the first time (402), the system identifies, via a processor having access to a blockchain database on a distributed computing system, a blockchain associated with a first product stored at a retail location, the blockchain containing a supply chain record of the first product from a manufacturer to the retail location (404). The system identifies a sale of the first product (406) and, in response to the sale of the first product, generates a new block for the blockchain, the new block including information regarding the sale (408). The system adds the new block to the blockchain, to yield a modified blockchain (410). The system then distributes the modified blockchain to the distributed computing system (412).

At a second time (414), the system receives a notification of a second product being returned to the product location (416). However, the system needs to determine if the product being returned is actually the product which was sold, or if the returner is attempting to fraud the retailer. The system retrieves the modified blockchain from the distributed computing system (418), then compares the second product to the new block, to yield a comparison (420). The system determines, based on the comparison, that the second product is the first product (422), and accepts the second product as a returned product (424). The system then updates the modified blockchain based on the returned product, to yield an updated blockchain (426) and distributes the updated blockchain to the distributed computing system (428).

In some configurations, the supply chain record can identify a serial number of the first product. The new block generated can then include, as part of the data, information such as: a time when the first product was sold, an identification of the retail location, the serial number, and a point of sale (the cash register or kiosk where the item was sold).

In addition to data about the sale, the new block can include customer information such as: a customer name, a customer address, a customer telephone number, and/or a customer e-mail address. Likewise, the new block may contain biometric data for the purchaser of the product, then compare that biometric data when the return is occurring. In such cases, the method may further include: receiving returner biometric data from a returner of the second product; comparing the returner biometric data to the purchaser biometric data, to yield a biometric comparison, where the determining that the second product is the first product is further based on the biometric comparison.

The method disclosed herein can be used for instances where the first product and/or the second product are digital products, or when the first and/or second products are tangible products.

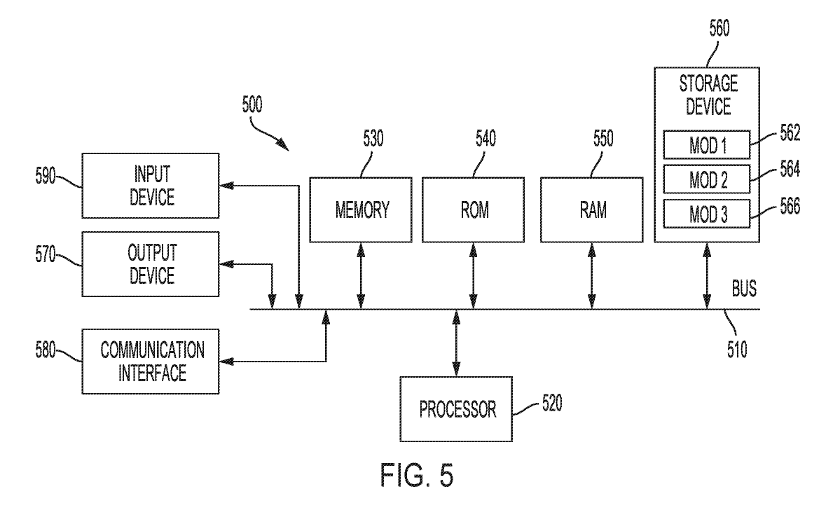

With reference to FIG. 5, an exemplary system 500 includes a general-purpose computing device 500, including a processing unit (CPU or processor) 520 and a system bus 510 that couples various system components including the system memory 530 such as read-only memory (ROM) 540 and random access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
at a first time:
identifying, via a processor having access to a blockchain database on a distributed computing system, a blockchain associated with a first product stored at a retail location, the blockchain containing a supply chain record of the first product from a manufacturer to the retail location;
identifying a sale of the first product;
in response to the sale of the first product, generating a new block for the blockchain, the new block including information regarding the sale;
adding the new block to the blockchain, to yield a modified blockchain; and
distributing the modified blockchain to the distributed computing system;
at a second time:
receiving a notification of a second product being returned to the product location;
retrieving the modified blockchain from the distributed computing system;
comparing the second product to the new block, to yield a comparison;
determining, based on the comparison, that the second product is the first product;
accepting the second product as a returned product;
updating the modified blockchain based on the returned product, to yield an updated blockchain; and
distributing the updated blockchain to the distributed computing system.

2. The method of claim 1, wherein the supply chain record identifies a serial number of the first product.

3. The method of claim 2, wherein the new block comprises:
a time when the first product was sold;
an identification of the retail location;
the serial number; and
a point of sale.

4. The method of claim 1, wherein the new block comprises customer information, the customer information comprising:
a customer name;
a customer address;
a customer telephone number; and
a customer e-mail address.

5. The method of claim 1, wherein the new block comprises purchaser biometric data associated with a purchaser of the first product.

6. The method of claim 5, further comprising:
receiving returner biometric data from a returner of the second product; and
comparing the returner biometric data to the purchaser biometric data, to yield a biometric comparison,
wherein the determining that the second product is the first product is further based on the biometric comparison.

7. The method of claim 1, wherein the first product and the second product are digital products.

8. A system comprising:
a processor having access to a blockchain database on a distributed computing system; and
a computer-readable storage medium having instructions stored which, when executed by the processor, cause the processor to perform operations comprising:
at a first time:
identifying a blockchain associated with a first product stored at a retail location, the blockchain containing a supply chain record of the first product from a manufacturer to the retail location;
identifying a sale of the first product;
in response to the sale of the first product, generating a new block for the blockchain, the new block including information regarding the sale;
adding the new block to the blockchain, to yield a modified blockchain; and
distributing the modified blockchain to the distributed computing system;
at a second time:
receiving a notification of a second product being returned to the product location;
retrieving the modified blockchain from the distributed computing system;
comparing the second product to the new block, to yield a comparison;
determining, based on the comparison, that the second product is the first product;
accepting the second product as a returned product;
updating the modified blockchain based on the returned product, to yield an updated blockchain; and
distributing the updated blockchain to the distributed computing system.

9. The system of claim 8, wherein the supply chain record identifies a serial number of the first product.

10. The system of claim 9, wherein the new block comprises:
a time when the first product was sold;
an identification of the retail location;
the serial number; and
a point of sale.

11. The system of claim 8, wherein the new block comprises customer information, the customer information comprising:
a customer name;
a customer address;
a customer telephone number; and
a customer e-mail address.

12. The system of claim 8, wherein the new block comprises purchaser biometric data associated with a purchaser of the first product.

13. The system of claim 12, the computer-readable storage medium having additional instructions stored which, when executed by the processor, cause the processor to perform operations comprising:
receiving returner biometric data from a returner of the second product; and
comparing the returner biometric data to the purchaser biometric data, to yield a biometric comparison,
wherein the determining that the second product is the first product is further based on the biometric comparison.

14. The system of claim 8, wherein the first product and the second product are digital products.

15. A non-transitory computer-readable storage medium having instructions stored which, when executed by a computing device having access to a blockchain database on a distributed computing system, cause the computing device to perform operations comprising:
at a first time:
identifying a blockchain associated with a first product stored at a retail location, the blockchain containing a supply chain record of the first product from a manufacturer to the retail location;
identifying a sale of the first product;
in response to the sale of the first product, generating a new block for the blockchain, the new block including information regarding the sale;
adding the new block to the blockchain, to yield a modified blockchain; and
distributing the modified blockchain to the distributed computing system;
at a second time:
receiving a notification of a second product being returned to the product location;
retrieving the modified blockchain from the distributed computing system;
comparing the second product to the new block, to yield a comparison;
determining, based on the comparison, that the second product is the first product;
accepting the second product as a returned product;
updating the modified blockchain based on the returned product, to yield an updated blockchain; and
distributing the updated blockchain to the distributed computing system.

16. The non-transitory computer-readable storage medium of claim 15, wherein the supply chain record identifies a serial number of the first product.

17. The non-transitory computer-readable storage medium of claim 16, wherein the new block comprises:
a time when the first product was sold;
an identification of the retail location;
the serial number; and
a point of sale.

18. The non-transitory computer-readable storage medium of claim 15, wherein the new block comprises customer information, the customer information comprising:
a customer name;
a customer address;
a customer telephone number; and
a customer e-mail address.

19. The non-transitory computer-readable storage medium of claim 15, wherein the new block comprises purchaser biometric data associated with a purchaser of the first product.

20. The non-transitory computer-readable storage medium of claim 19, having additional instructions stored which, when executed by the computing device, cause the computing device to perform operations comprising:
receiving returner biometric data from a returner of the second product; and
comparing the returner biometric data to the purchaser biometric data, to yield a biometric comparison,
wherein the determining that the second product is the first product is further based on the biometric comparison.
